(19) United States
(12) Patent Application Publication
(10) Pub. No.: US 2007/0184833 A1
(43) Pub. Date: Aug. 9, 2007

(54) Method and system for user roaming and service roaming in a digital broadcasting system

(75) Inventors: Yiling Xu, Suwon-si (KR); Jae-Yeon Song, Seoul (KR); Jong-Hoon Ann, Suwon-si (KR); Kook-Heui Lee, Yongin-si (KR); Hye-Young Lee, Seoul (KR); Bo-Sun Jung, Seongnam-si (KR); Jong-Hyo Lee, Pyeongtaek-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/651,154

(22) Filed: Jan. 9, 2007

(30) Foreign Application Priority Data
Jan. 12, 2006 (KR) 3684/2006
Feb. 27, 2006 (KR) 18945/2006

(51) Int. Cl. H04Q 7/20

(52) U.S. Cl. 455/432.1

(57) ABSTRACT

A method and apparatus for receiving user roaming and service roaming services from a foreign network in a terminal that has moved from a home network to the foreign network in a digital broadcasting system are provided, in which the terminal receives an ESG from a foreign service provider after entering into the foreign network, selects a roaming type between user roaming and service roaming by determining if an intended broadcasting service is provided from the foreign network, referring to the ESG, receives the intended service from the foreign service provider, if the roaming type is the user roaming, and receives the intended service from a home service provider over the foreign network, if the roaming type is the service roaming.

### PRIORITY

This application claims priority under 35 U.S.C. §119(a) to an application filed in the Korean Intellectual Property Office on Jan. 12, 2006 and assigned Serial No. 2006-3684 and an application filed in the Korean Intellectual Property Office on Feb. 27, 2006 and assigned Serial No. 2006-18945, the entire disclosure of both of which is herein incorporated by reference.

### BACKGROUND OF THE INVENTION

1. Field of the Invention

The present invention generally relates to digital broadcasting. More particularly, the present invention relates to a method and system for enabling a receiving terminal to roam from a home network to a foreign network.

2. Description of the Related Art

Today, the development of communication and broadcasting technologies has led to provisioning of mobile broadcasting in a broadcasting system or a mobile communication system. The mobile broadcasting under consideration sends packet data on a broadcast channel as well as provides a typical broadcasting service confined to audio and video. Mobile broadcasting starts with service discovery and subscription by a mobile terminal such as a mobile broadcasting-enabled portable phone, laptop computer, Personal Digital Assistant (PDA), or the like, followed by transmission of control information associated with service reception, transmission of a service, and reception of the service by the mobile terminal.

Open Mobile Alliance (OMA) is one of standardization bodies for developing interoperable mobile service enablers. The OMA focuses on standardization of a variety of applications including mobile games, Internet service, and the like. In particular, the OMA Browser and Content (BAC) Mobile Broadcasting SubWorking Group (BCAST) is working on a technology of providing a broadcasting service to mobile terminal capable of communicating with an interactive network.

To receive a broadcasting service in a mobile broadcasting system, a terminal first receives a description about the service itself, accounting information of the service, and a Service Guide (SG) that tells how the service can be received, and then receives the service using the SG.

When the terminal moves from a network of a home service provider to which the user has subscribed (i.e. home network) to a network of a foreign service provider (i.e. foreign network), the user may want to receive a broadcasting service of the home network or a service of the foreign service provider with which the home service provider has a roaming agreement. Accordingly, there is a need for a procedure and system for efficiently supporting roaming of broadcasting services in a mobile broadcasting system.

### SUMMARY OF THE INVENTION

An aspect of the present invention is to address at least the problems and/or disadvantages enumerated above and to provide at least the advantages described below. Accordingly, an aspect of the present invention is to provide a method and system for receiving an intended broadcasting service through user roaming and service roaming by a terminal in a foreign network of a foreign service provider other than a home service provider in a digital broadcasting system.

In accordance with another aspect of the present invention, there is provided a roaming method for a terminal in a mobile broadcasting system, in which the terminal receives an ESG from a foreign service provider after entering into a foreign network operated by the foreign service provider, selects a roaming type between user roaming and service roaming by determining if an intended broadcasting service is provided from the foreign network. Referring to the ESC, the mobile terminal receives the intended service from the foreign service provider, if the roaming type is the user roaming, and receives the intended service from a home service provider over the foreign network, if the roaming type is the service roaming.

In accordance with yet another aspect of the present invention, there is provided a method of providing a roaming service to a terminal in a mobile broadcasting system, in which a roaming proposal message is received from a terminal that has entered from a home network operated by a home service provider to a foreign network operated by a foreign service provider, it is determined whether a roaming type indicated by the roaming proposal message is user roaming or service roaming. An intended service requested by the terminal is provided to the terminal from the foreign service provider, if the roaming type is the user roaming, and the intended service is received from the home service provider and provided to the terminal, if the roaming type is the service roaming.

In accordance with a further aspect of the present invention, there is provided a terminal apparatus for receiving a roaming service in a mobile broadcasting system, in which a broadcasting receiver accesses a broadcasting network and receives data and signaling of a broadcasting service. An interactive adaptor accesses an interactive network connected to the broadcasting network and sends and receives signals associated with the roaming service. A mobility manager selects a roaming type between user roaming and service roaming by determining whether an intended broadcasting service is provided from a foreign network operated by a foreign service provider based on an ESG received from the foreign service provider after entering into the foreign network. The mobility manager controls the broadcasting receiver to receive the intended service from the foreign service provider, if the roaming type is the user roaming, and controls the interactive adaptor to receive the intended service from a home service provider over the interactive network, if the roaming type is the service roaming.

In accordance with still another aspect of the present invention, there is provided a network apparatus for providing a roaming service to a terminal in a mobile broadcasting system, in which a terminal capable of receiving a broadcasting service has subscribed to a home service provider, and a foreign service provider receives a roaming proposal message from the terminal when the terminal enters from a home network operated by the home service provider into a foreign network. It determines whether a roaming type indicated by the roaming proposal message is user roaming or service roaming, provides an intended service of the terminal to the terminal from the foreign service provider if the roaming type is the user roaming, and receives the intended service from the home service provider and provides the intended service to the terminal, if the roaming type is the service roaming.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram of a mobile broadcasting-associated network architecture according to the present invention;

FIG. 2 is a block diagram of a roaming-associated network architecture according to the present invention;

FIG. 3 is a flowchart showing an operation of a receiver according to the present invention;

FIG. 4 is a flowchart of an operation of a foreign network according to the present invention;

FIG. 5 is a block diagram of a transmitter according to the present invention;

FIG. 6 is a block diagram of the receiver according to the present invention;

FIGS. 7A and 7B are flow diagrams showing signal flows for user roaming and service roaming according to the present invention;

FIG. 8 is a flowchart showing an operation of the receiver according to the present invention;

FIG. 9 is a flowchart showing an operation of the transmitter according to the present invention; and

FIG. 10 is a flow diagram showing a signal flow according to the present invention.

### DETAILED DESCRIPTION OF PREFERRED EMBODIMENTS

The following detailed construction and elements are provided to assist in a better understanding of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

In a system according to the present invention, when a receiver (i.e. terminal) which has subscribed to a home service provider roams from a service area of the home service provider (a home service area) to a service area of a foreign service provider (a foreign service area), the terminal first receives an Electronic Service Guide (ESG) from the foreign service provider and determines a roaming type based on a service list included in the ESG Then the terminal performs one of user roaming and service roaming according to the roaming type. User roaming means that a user has access to the services provided from a foreign network, and service roaming means that the same services provided from a home network can be accessed in a foreign network. A service that the terminal receives in the foreign network may have the same contents as or different contents from a service received from the home network before roaming.

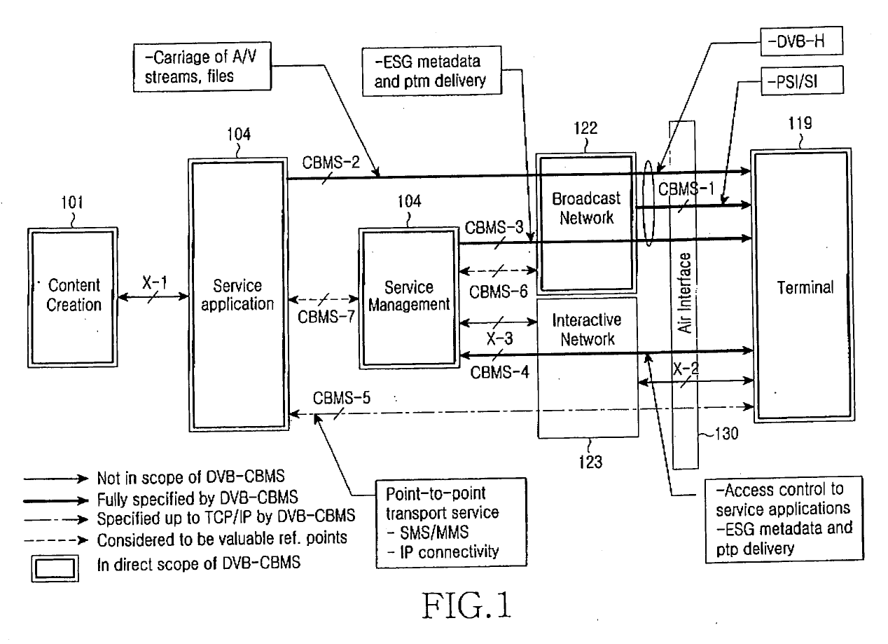

Referring to FIG. 1, the blocks shown are logical entities distinguished by their functions. They can be separated physically, or reside in the same server. A Content Creator (CC) 101 produces content sources for a broadcasting service. A Service Application (SA) 104 generates a specific service out of the content sources and metadata additionally required for service configuration. A Service Manager (SM) 108 has the functionalities of service configuration, resource allocation, ESG provisioning, security, and the like.

A broadcast network 122 is a network for sending broadcasting service data. The broadcast network 122 can be a Digital Video Broadcasting-Handheld (DVB-H) system, for example. An interactive network 123 is typically a Universal Mobile Telecommunications System (UMTS) or International Mobile Telecommunications-2000 (IMT-2000) cellular network, to which the present invention is not limited. Hence, the interactive network 123 can be any type of network that receives information or requests from terminals and responds to the transmitted information or requests to the terminals. A terminal 119 is a user terminal capable of accessing the interactive network 123 and receiving broadcasting services.

Interfaces between entities including the above-described logical entities are defined in FIG. 1.

X-1, X-2 and X-3 interfaces are reference points between the broadcast network and other entities. Generally, these interfaces are not used in Digital Video Broadcasting-Handheld (DVB-H) based interactive standards. X-1 interfaces between CC 101 and SA 104, X-2 interfaces between interactive network 123 and terminal 119, and X-3 interfaces between SM 108 and interactive network 123.

The Convergence of Broadcasting and Mobile Service-1 (CBMS-1) interface carries broadcasting-associated signals, and the CBMS-2 interface delivers contents such as audio, video, files, etc. The CBMS-3 interface delivers ESG, the CBMS-4 interface delivers ESG by Point-to-Point (PtP) transmission, and the CBMS-5 delivers Short Message Service (SMS) messages and Multimedia Messaging Service (MSS) messages by PtP transmission. The CBMS-6 interface conveys configuration parameters including the number of services for DVB-H transmission, allocated bandwidths, etc. The CBMS-7 interface conveys service application declarations and metadata. Since the above description of the interfaces is made of major functions of the interfaces, it is to be understood that it does not limit the functional scope of the interfaces.

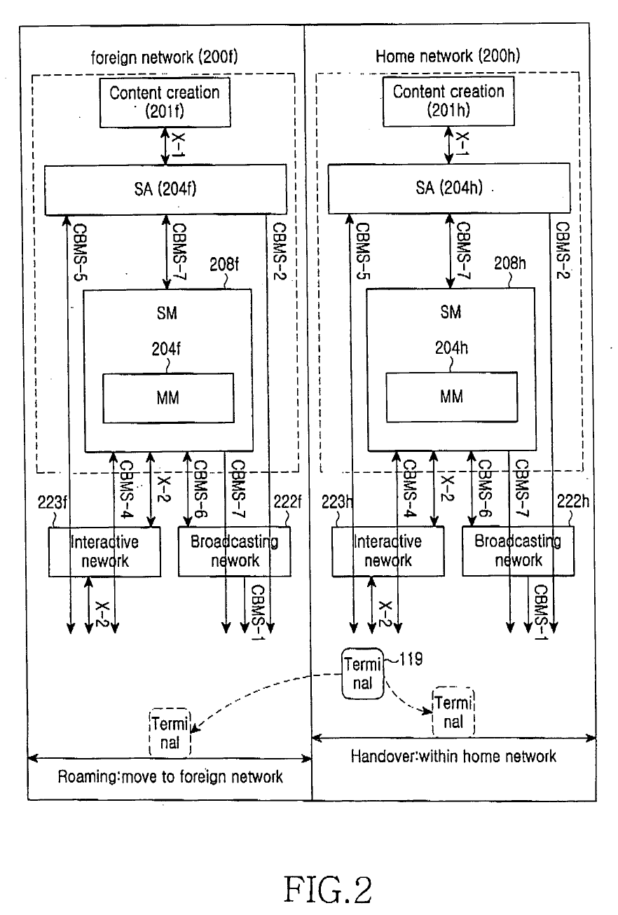

Referring to FIG. 2, basic blocks, 201f and 201f, 204f and 204h, 208f and 208h, interactive networks 223f and 223h, and broadcast networks 222f and 222h operate as described with reference to FIG. 1. The entities of a foreign network 200f and the entities of a home network 200h are distinguished by adding ‘f’ and ‘h’ to the reference numerals. Logical entities associated with roaming are Mobility Managers (MMs) 240f and 240h in the SMs 208f and 208h. The MMs 240f and 240h are responsible for roaming proposal processing and terminal user authorization for terminal 119 which is located in home network 200h or roams to foreign network 200f.

The receiving terminal is capable of accessing the interactive network and the MM of the foreign service provider is aware that the terminal is located in the foreign network. The ESG of the foreign service provider is sent by “free air” service so that any terminal can receive the ESG and interpret it.

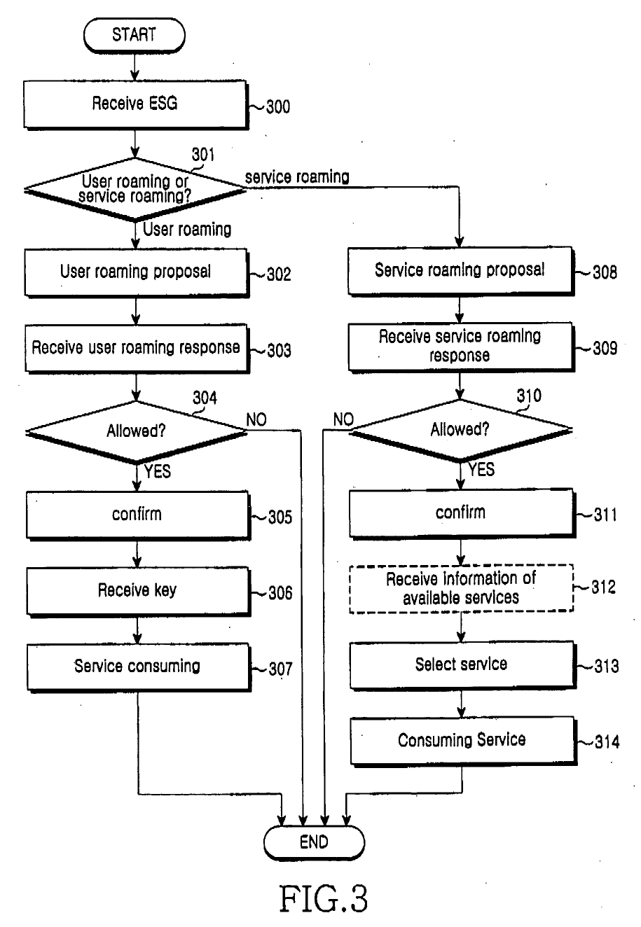

Referring to FIG. 3, the terminal moves from a home network to a foreign network and receives an ESG from the foreign network in step 300. In step 301, the terminal determines from the ESG if an intended service is provided in the foreign network and selects a roaming type according to whether the intended service is available. The intended service has the same contents as or different contents from a service received from the home network before roaming. If the intended service is available in the foreign network, which means that user roaming is required, the terminal sends a user roaming proposal message to a foreign service provider of the foreign network in step 302.

The terminal receives a response message for the user roaming proposal message in step 303 and determines from the response message if a roaming service is allowed for the terminal in the foreign network in step 304. If the roaming service is allowed, the terminal sends a confirm message in step 305, receives an access key (e.g. a descrambling key or deciphering key) by which to access the broadcasting data of the intended service from the foreign service provider in step 306, and receives the intended service using the access key from the foreign service provider in step 307. The response message allowing the roaming service includes accounting information regarding the use of the service in the foreign network. On the other hand, if the roaming service is not allowed in step 304, the procedure ends.

If the intended service is not available in the foreign network in step 301, which means that service roaming is required, the terminal sends a service roaming proposal message to the foreign service provider in step 308 and receives a response message for the service roaming proposal message in step 309. The terminal determines from the response message if a roaming service is allowed for the terminal in the foreign network in step 310. If the roaming service is allowed, the terminal sends a confirm message in step 311. The response message allowing the roaming service includes accounting information regarding the use of the service in the foreign network.

In step 312, the terminal can receive a service list including information about available services that can be provided to the roaming user from the home network from the foreign service provider. In this case, the terminal selects an intended service from the service list and notifies the foreign service provider of the selected service. The elected service may have the same contents as or different contents from the intended service depending on the availability of which the terminal determines a roaming type in step 301. In step 314, the terminal receives the selected service through the foreign service provider or over the interactive network. The service list may be provided in an ESG or an ESG-like form. The available service information may include access parameters (e.g. access keys) for use in receiving the available services.

It can be further contemplated as another preferred embodiment of the present invention that if the terminal continues to receive the same service of the home network from the foreign network, the foreign service provider can be informed of the intended service from the terminal or the home service provider. In this case, steps 312 and 313 are not performed.

The operation of the foreign network takes place mostly in the Mobility Managers (MM) of the foreign network (hereinafter referred to as the foreign MM). Thus, the following description focuses on the operation of the foreign MM.

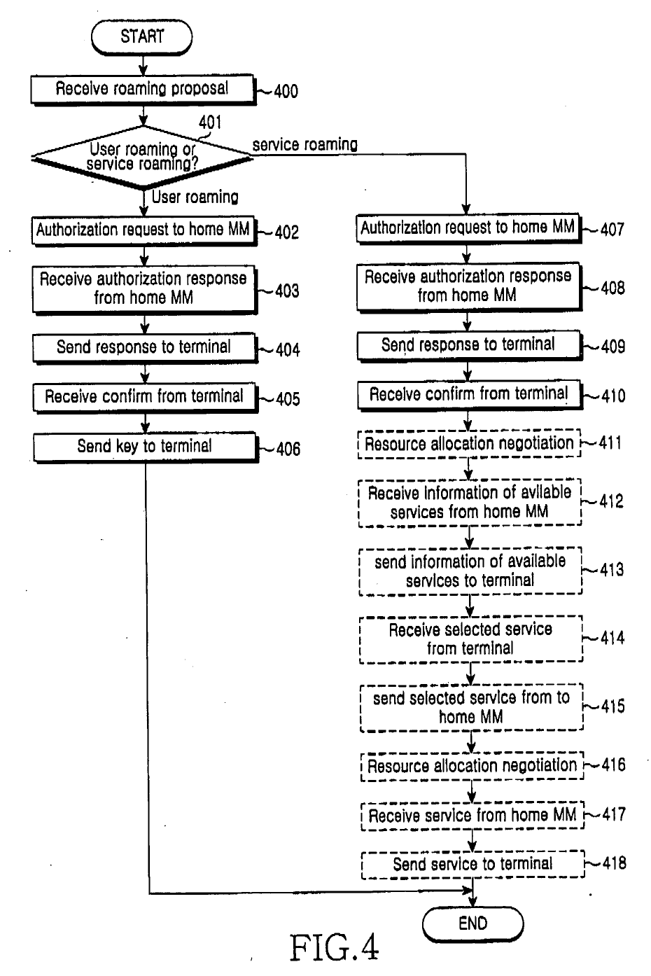

Referring to FIG. 4, the foreign MM receives a roaming proposal message from the terminal in step 400 and determines a roaming type by analyzing the roaming proposal message in step 401. If the roaming proposal message indicates user roaming, the foreign MM sends a user authorization request to the MM of the home service provider (hereinafter, referred to as the home MM) in step 402. Upon receipt of a response message for the user authorization request message in step 403, the foreign MM sends the response message to the terminal in step 404. After receiving a confirm message from the terminal in step 405, the foreign MM sends a service access key to the terminal in step 406.

On the other hand, if the roaming proposal message indicates service roaming, the foreign MM sends a user authorization request to the home service provider in step 407. Upon receipt of a response message for the user authorization request message in step 408, the foreign MM sends the response message to the terminal in step 409.

The foreign MM receives a confirm message from the terminal in step 410. Then, in step 411 or 416, a resource allocation negotiation for service provisioning is conducted among the foreign MM, the home MM, and the interactive network over which a service is provided. During the resource allocation negotiation, parameters representing Quality of Service (QoS) for service provisioning to the roaming user and information about resource allocation are exchanged and parameters for actual setup of a service transmission path are shared among the three entities. The resource allocation negotiation may take place in step 411 before the terminal determines its intended service or in step 416 after the terminal determines its intended service. [Dotted lines mean optional steps according to system implementation.]

If the foreign MM receives available service information for the roaming use from the home MM in step 412, it forwards the available service information to the terminal in step 413. The foreign MM receives information about a service that the terminal has selected based on the available service information from the terminal in step 414 and forwards the selected service information to the home MM in step 415. It can be further contemplated as another preferred embodiment of the present invention that if the terminal continues to receive the same service of the home network from the foreign network, the foreign service provider can be informed of the intended service from the terminal or the home service provider. In this case, steps 412 to 415 are not performed.

After the afore-described resource allocation negotiation, the foreign service providers provide the selected service which is indicated by the selected service information and received from the home MM to the terminal over the interactive network in steps 417 and 418. Steps 417 and 418 are needed when the terminal-selected service is provided to the interactive network through the foreign service provider. When the service is directly provided to the interactive network from the home service provider, steps 417 and 418 are not performed.

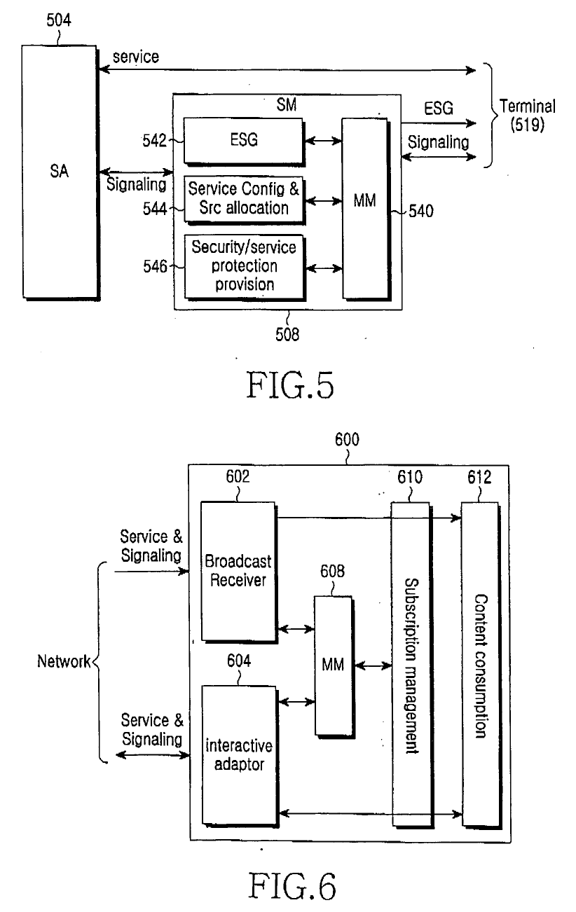

Referring to FIG. 5, only entities that implement logical functions associated with preferred embodiments of the present invention within the SMs of the home network and the foreign network are shown. In an SM 508, an ESG entity 542 creates an ESG and sends it. A service configuration & source allocation entity 544 is responsible for service configuration and network resource allocation. A security/service protection provision entity 546 is responsible for security and authorization, service protection, and service provisioning. These three entities 542, 544 and 546 are connected to an MM 540 and perform functions needed for roaming. The MM 540 carries out operations associated with the mobility of terminals, particularly operations associated with the roaming service.

The MM 540 has the following functionalities.

reception of a terminal's roaming proposal and transmission of a roaming response

user authorization signaling with the MM of the foreign service provider

management of basic information and accounting information about the terminal that wants roaming

communication with other entities within the SM, for roaming.

Referring to FIG. 6, a receiver 600 is a terminal equipped with an interactive adaptor 604 for connecting to the interactive network as well as a broadcasting receiver 602. Roaming-associated signals from the broadcast receiver 602 and the interactive adaptor 604 are provided to a Mobility Manager (MM) 608. To perform a roaming-associated operation as described with reference to FIG. 3, MM 608 is connected to a subscription manager 610 for operating with regard to service subscription and a content consumer 612 for providing a broadcasting service to the user. MM 608 sends a roaming-associated signal to the interactive network through interactive adaptor 604.

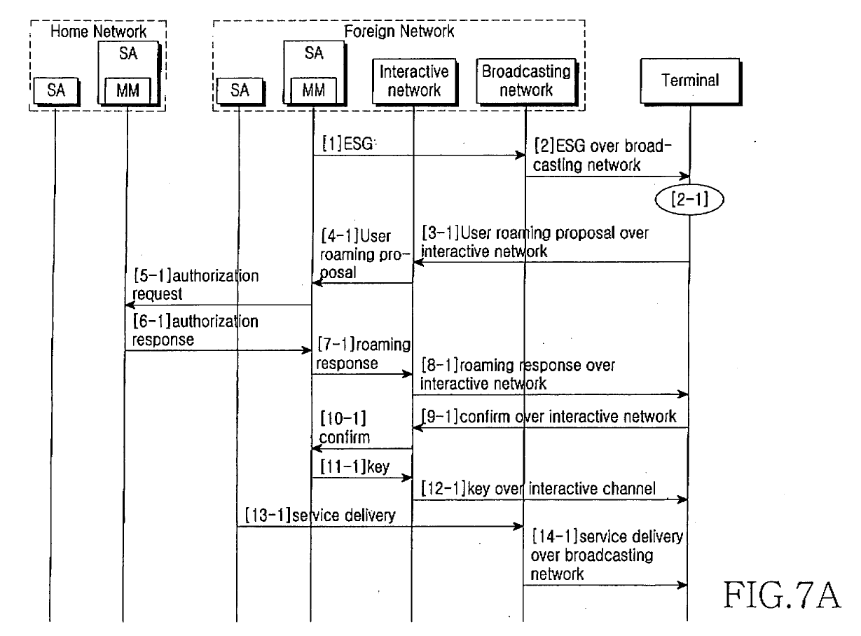

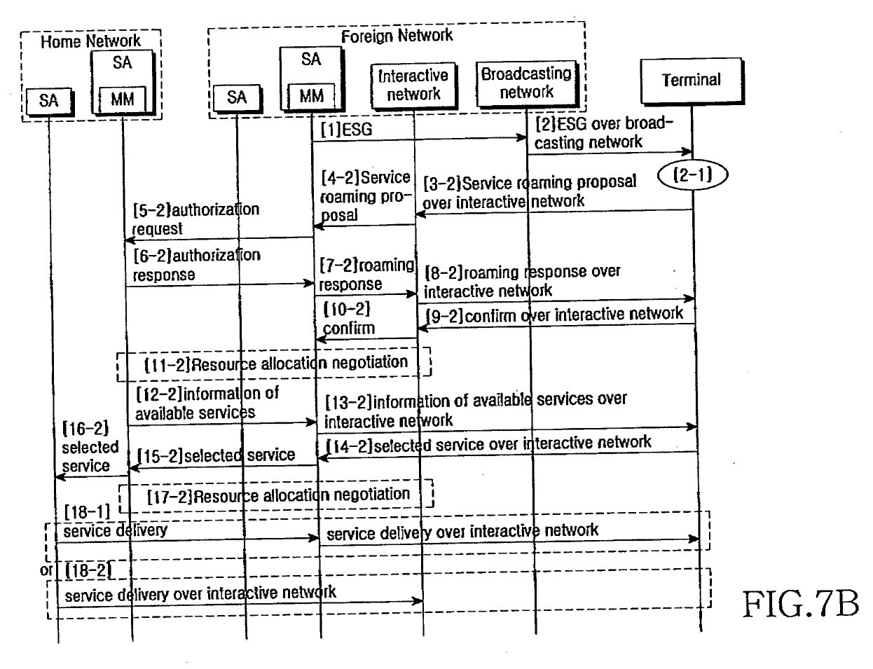

Referring to FIGS. 7A and 7B, signaling between the foreign network and the terminal is carried out over the interactive network. The terminal receives an ESG of the foreign service provider from the foreign MM within the foreign Subscription Management (SM) over a broadcasting network in the foreign service area in steps [1] and [2]. The ESG is not targeted at roaming users but is a typical ESG broadcast over the broadcasting network. The terminal determines a roaming type based on available service information included in the ESG in step [2-1].

If the terminal decides on user roaming in step [2-1], it sends a user roaming proposal message to the foreign service provider over the interactive network in steps [3-1] and [4-1]. The user roaming proposal message may include information indicating a service that the terminal wants. The foreign MM sends an authorization request for the roaming-requesting terminal to the home service provider in step [5-1]. When the home service provider authorizes the terminal in step [6-1], the foreign MM sends a roaming response message to the terminal over the interactive network in steps [7-1] and [8-1]. The terminal replies to the foreign MM with a confirm message for the roaming response message over the interactive network in steps [9-1] and [10-1]. To enable the terminal to receive the intended service, the foreign MM sends a service access key to the terminal over the interactive network in steps [11-1] and [12-1]. Using the service access key, the terminal can access the intended service provided from the foreign SA over the broadcasting network in steps [13-1] and [14-1].

If the terminal decides on service roaming in step [2-1], it sends a service roaming proposal message to the foreign service provider over the interactive network in steps [3-2] and [4-2] as shown in FIG. 7B. The foreign MM performs user authorization by signaling with the home MM in steps [5-2] and [6-2]. If the user authorization is successful, the foreign MM sends a roaming response message to the terminal over the interactive network in steps [7-2] and [8-2] and receives a confirm message from the terminal in steps [9-2] and [10-2].

In step [11-2] or [17-2], resource allocation negotiation is conducted among the home MM, the foreign MM, and the interactive network. Meanwhile, after the user authorization, the home MM sends available service information for the roaming user to the foreign MM in step [12-2] and the foreign MM sends the available service information to the terminal over the interactive network in step [13-2]. The terminal selects an intended service based on the available service information and notifies the foreign MM of the selected service by selected service information in step [14-2]. The foreign MM sends the selected service information to the home MM in step [ 15-2].

The home MM sends the selected service information to the home SA responsible for actual service delivery in step [16-2]. In the case where the home service provider sends the selected service directly to the terminal over the interactive network without the intervention of the foreign service provider, information about an entry point of the interactive network, for service delivery and information about the terminal can be sent to the home SA in step [16-2]. The home service provider sends the selected service to the terminal over the interactive network in steps [18-1] and [18-2]. For example, the home service provider sends the selected service to the foreign service provider and then the foreign service provider forwards the selected service to the terminal over the interactive network in step [18-1]. Alternatively, the home service provider provides the selected service directly to the terminal over the interactive without the intervention of the foreign service provider in step [18-2].

Table 1 to Table 6 below list fields of the messages involved in the procedures illustrated in FIGS. 7A and 7B. The sequence and names of the message fields are not limited to the tables and some of the message fields are optional.

TABLE 1
Roaming Proposal

| Name | Description |
|---|---|
| Roaming proposal | Identifier of roaming proposal message |
| Roaming type | Identifier of roaming type: User or Service |
| User ID | User identity |
| Home Network ID | Identity of network that terminal belongs to |
| Service ID | Identifier of service that terminal wants to consume |
| | * in service roaming, here it means information of |
| | available home service. |

TABLE 2
Authorization Request

| Name | Description |
|---|---|
| Authorization request ID | Identifier of authorization request message |
| User ID | User identity |
| Visited Network ID | Identity of network that terminal is in |
| Roaming type | Roaming service that terminal wants to |
| | consume: User or Service |

TABLE 3
Authorization Response

| Name | Description |
|---|---|
| Authorization response ID | Identifier of authorization response |
| | message |
| Authorization result | Terminal's request for roaming is allowed |
| | or not |

TABLE 4
Roaming Response

| Name | Description |
|---|---|
| Roaming response ID | Identifier of roaming response message |
| Roaming type | Identifier of roaming type: User or Service |
| Roaming result | Roaming request is allowed or not |
| Charging | Based on charging information |

TABLE 5
Confirm

| Name | Description |
|---|---|
| Confirm ID | Identifier of confirm message |
| Agree or not | Confirm information to MM |

TABLE 6
Select Service

| Name | Description |
|---|---|
| Select service ID | Identifier of Select service message |
| Service ID | Identifier of service that terminal wants to consume |

In accordance with another preferred embodiment of the present invention, if omission of authorization is agreed between the home service provider and the foreign service provider or if no authorization is required between different networks, the user is allowed to carry out the use of roaming or service roaming without authorization. Consequently, the user can perform faster roaming.

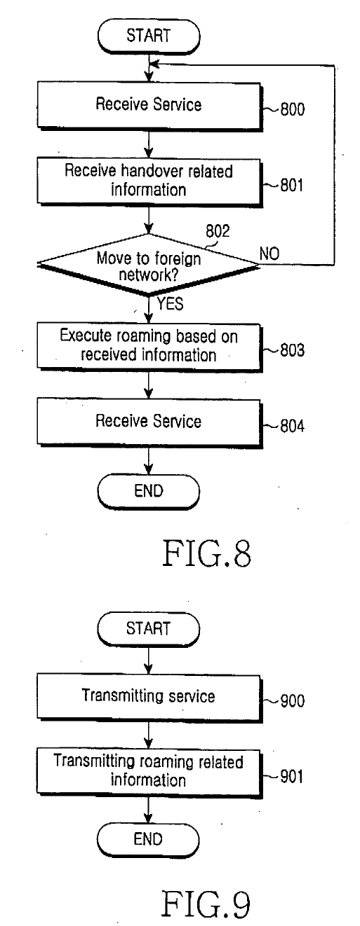

Referring to FIG. 8, the terminal is receiving a service from the home network in step 800. In step 801, the terminal receives handover information from the home service provider in the home network. The handover information further includes roaming information indicating whether authorization is required during roaming in addition to typical handover information.

According to European Telecommunications Standards Institute (ETSI) Technical Report (TR) 101 211 Digital Video Broadcasting (DVB), Guidelines on implementation and usage of Service Information (SI), when the user needs additional information, the network sends the additional information to the terminal by a linkage descriptor. The home service provider may send to the user roaming information indicating that a service from the foreign service provider is available to the user without authorization by a reserved and unused part of hand-over_type in the linkage descriptor. An exemplary linkage descriptor is illustrated in Table 7.

TABLE 7

| | | Number | Identi- |
|---|---|---|---|
| Syntax | | of bits | fier |
| linkage_descriptor( ){ | | | |
| Descriptor_tag | | 8 | uimsbf |
| Descriptor_length | | 8 | uimsbf |
| transport_stream_id | | 16 | uimsbf |
| original_network_id | | 16 | uimsbf |
| service_id | | 16 | uimsbf |
| linkage_type | | 8 | uimsbf |
| if (linkage_type !=0x08){ | | | |
| | for (i=0;i<N;i++){ | | |
| | private_data_byte | 8 | bslbf |
| } | | | |
| } | | | |
| if (linkage_type ==0x08){ | | | |
| | Hand-over_type | 4 | bslbf |

| | | |
|---|---|---|
| reserved_future_use | 3 | bslbf |

| | | |
|---|---|---|
| origin_type | 1 | bslbf |

if (hand-over_type ==0x01
∥ hand-over_type ==0x02

∥ hand-over_type ==0x03){

| | | |
|---|---|---|
| network_id | 16 | uimsbf |

| } | |
|---|---|
| | if (origin_type ==0x00){ |

| | | |
|---|---|---|
| initial_service_id | 16 | uimsbf |

}

| | |
|---|---|
| for (i=0;i<N;i++){ | |
| private_data_byte | ‘0’ roaming |

| with | |
|---|---|
| authorization | |
| ‘1’ roaming | bslbf |
| without | |
| authorization | |

}
}
}

In Table 7, private_data_byte is set to 0, if it indicates roaming with authorization and it is set to 1, if it indicates roaming without authorization. Other information fields having no relation to roaming information will not be described herein.

The format of the linkage descriptor is for illustrative purposes and thus it is to be clearly understood that the present invention is not limited to Table 7. It can be further contemplated as another preferred embodiment of the present invention that if the terminal can access the interactive network, it requests necessary information, particularly roaming information to the interactive network directly or via the homer service provider, and the home service provider sends the roaming information to the terminal over the interactive network or the broadcasting network.

In step 802, the terminal locates itself. If the terminal has moved to a foreign network, the terminal goes to step 803 and otherwise, it returns to step 800 to continue to receive the on-going service. In step 803, the terminal performs roaming to the foreign network based on the roaming information. Referring to the roaming information, the terminal may perform only frequency tuning for accessing the foreign network by identifying a changed frequency and Transport Stream (TS) without the need for authorization. The terminal continues to receive the selected service at the tuned frequency in step 804.

Referring to FIG. 9, while providing a service in step 900, the transmitter sends roaming information to support service roaming and user roaming for terminals receiving the service in the network. The roaming information is the handover information described with reference to FIG. 8 and Table 7 and/or terminal-requested information. The roaming information indicates whether the terminal can receive a service from the foreign service provider without authorization.

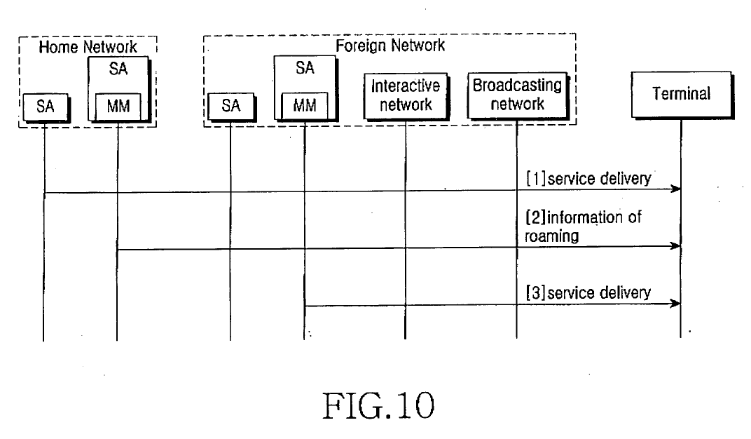

Referring to FIG. 10, the terminal receives a user-selected service from the home network in step [1] and receives roaming information from the home MM in step [2]. Steps [1] and [2] are not always sequential. If roaming information is sent by service-related control information, Program Specific Information (PSI)/Service Information (SI), steps [ 1] and [2] may take place concurrently.

Later, when the terminal moves out of the home network and enters into the foreign network, it performs user roaming or service roaming to the foreign network without authorization according to the roaming information. The terminal then receives a user-selected service provided by the home service provider or the foreign service provider in step [3].

As is apparent from the above description, a terminal determines a roaming type referring to a received ESG and receives user roaming or service roaming according to the roaming type in a mobile broadcasting system according to the preferred embodiments of the present invention. Therefore, the terminal can receive an intended service successfully from a foreign network.

While the invention has been shown and described with reference to certain preferred embodiments of the present invention thereof, it will be understood by those skilled in the art that various changes in form and details may be made therein without departing from the spirit and scope of the present invention as further defined by the appended claims and their equivalents.

What is claimed is:

1. A roaming method for a terminal in a mobile broadcasting system, comprising:
receiving an Electronic Service Guide (ESG) from a foreign service provider after entering into a foreign network operated by the foreign service provider;
selecting a roaming type between user roaming and service roaming by determining if an intended broadcasting service is provided from the foreign network, referring to the ESG;
receiving the intended service from the foreign service provider, if the roaming type is the user roaming; and
receiving the intended service from a home service provider over the foreign network, if the roaming type is the service roaming.

2. The roaming method of claim 1, further comprising:
sending a user roaming proposal message indicating the user roaming to the foreign service provider and receiving a response message for the user roaming proposal message from the foreign service provider, if the roaming type is the user roaming;
sending a confirm message to the foreign service provider, if the response message allows provisioning of the intended service in the foreign network; and
receiving an access key for receiving the intended service from the foreign service provider.

3. The roaming method of claim 2, wherein at least one of the user roaming proposal message, the response message, and the confirm message is delivered over an interactive network connected to the foreign service provider and accessible to the terminal.

4. The roaming method of claim 1, further comprising:
sending a service roaming proposal message indicating the service roaming to the foreign service provider and receiving a response message for the service roaming proposal message from the foreign service provider, if the roaming type is the service roaming;
sending a confirm message to the foreign service provider, if the response message allows provisioning of the intended service in the foreign network; and
performing resource allocation negotiation for provisioning of the intended service between the home service provider and the foreign service provider.

5. The roaming method of claim 4, wherein at least one of the service roaming proposal message, the response message, and the confirm message is delivered over an interactive network accessible to the terminal.

6. The roaming method of claim 1, wherein receiving the intended service from a home service provider over the foreign network, if the roaming type is the service roaming, which comprises receiving broadcasting data of the intended service from the home service provider over an interactive network accessible to the terminal.

7. The roaming method of claim 1, wherein receiving the intended service from a home service provider over the foreign network, if the roaming type is the service roaming, which comprises receiving broadcasting data of the intended service from the home service provider over a broadcasting network belonging to the foreign service provider.

8. The roaming method of claim 1, further comprising:
receiving available service information for a roaming user from the home service provider through the foreign service provider, if the roaming type is the service roaming;
selecting the intended service based on the available service information and notifying the foreign service provider of the selected service.

9. The roaming method of claim 1, further comprising:
receiving from the home service provider roaming information indicating if user authorization is required during roaming to the foreign network; and
performing roaming to the foreign network without the user authorization for the terminal between the home service provider and the foreign service provider, if the roaming information indicates that the user authorization is not required.

10. A method of providing a roaming service to a terminal in a mobile broadcasting system, comprising:
receiving a roaming proposal message from a terminal that has entered from a home network operated by a home service provider to a foreign network operated by a foreign service provider, and determining whether a roaming type indicated by the roaming proposal message is user roaming or service roaming;
providing an intended service to the terminal from the foreign service provider, if the roaming type is the user roaming; and
receiving the intended service from the home service provider and providing the intended service to the terminal, if the roaming type is the service roaming.

11. The method of claim 10, further comprising:
sending a response message for the roaming proposal message to the terminal, the response allowing the user roaming, if the roaming type is the user roaming; and
providing an access key for the intended service to the terminal, upon receipt of a confirm message from the terminal.

12. The method of claim 11, wherein at least one of the roaming proposal message, the response message, and the confirm message is delivered over an interactive network connected to the foreign service provider and accessible to the terminal.

13. The method of claim 10, further comprising:
sending a response message for the roaming proposal message, the response message allowing the service roaming, if the roaming type is the service roaming; and
performing resource allocation negotiation for provisioning of the intended service between the home service provider and the foreign service provider, upon receipt of a confirm message from the terminal.

14. The method of claim 13, wherein at least one of the roaming proposal message, the response message, and the confirm message is delivered over an interactive network accessible to the terminal.

15. The method of claim 10, wherein receiving the intended service from the home service provider and providing the intended service to the terminal, if the roaming type is the service roaming, which comprises sending broadcasting data of the intended service from the home service provider to the terminal over an interactive network accessible to the terminal.

16. The method of claim 10, wherein receiving the intended service from the home service provider and providing the intended service to the terminal, if the roaming type is the service roaming, which comprises sending broadcasting data of the intended service from the home service provider to the terminal over a broadcasting network belonging to the foreign service provider.

17. The method of claim 10, further comprising:
sending available service information for a roaming user from the home service provider to the terminal through the foreign service provider, if the roaming type is the service roaming; and
notifying the foreign service provider of the intended service selected based on the available service information from the terminal.

18. The method of claim 10, further comprising:
sending roaming information from the home service provider to the terminal, the roaming information indicating whether user authorization is required during roaming to the foreign network; and
performing roaming to the foreign network without the user authorization for the terminal between the home service provider and the foreign service provider, if the roaming information indicates that the user authorization is not required.

19. A terminal apparatus for receiving a roaming service in a mobile broadcasting system, comprising:
a broadcasting receiver for accessing a broadcasting network and receiving data and signaling of a broadcasting service;
an interactive adaptor for accessing an interactive network connected to the broadcasting network and sending and receiving signals associated with the roaming service; and
a mobility manager (MM) for
selecting a roaming type between user roaming and service roaming by determining if an intended broadcasting service is provided from a foreign network operated by a foreign service provider based on an Electronic Service Guide (ESG) received from the foreign service provider after entering into the foreign network,
controlling the broadcasting receiver to receive the intended service from the foreign service provider, if the roaming type is the user roaming, and controlling the interactive adaptor to receive the intended service from a home service provider over the interactive network, if the roaming type is the service roaming.

20. The terminal apparatus of claim 19, wherein if the roaming type is the user roaming, the mobility manager sends a user roaming proposal message indicating the user roaming to the foreign service provider and receives a response message for the user roaming proposal message from the foreign service provider, sends a confirm message to the foreign service provider, if the response message allows provisioning of the intended service in the foreign network, and receives an access key for receiving the intended service from the foreign service provider.

21. The terminal apparatus of claim 20, wherein at least one of the user roaming proposal message, the response message, and the confirm message is delivered over the interactive network connected to the foreign service provider and accessible to the terminal.

22. The terminal apparatus of claim 19, wherein if the roaming type is the service roaming, the mobility manager sends a service roaming proposal message indicating the service roaming to the foreign service provider, receives a response message for the service roaming proposal message from the foreign service provider, sends a confirm message to the foreign service provider, if the response message allows provisioning of the intended service in the foreign network, and performs resource allocation negotiation for provisioning of the intended service between the home service provider and the foreign service provider.

23. The terminal apparatus of claim 22, wherein at least one of the service roaming proposal message, the response message, and the confirm message is delivered over the interactive network accessible to the terminal.

24. The terminal apparatus of claim 19, wherein if the roaming type is the service roaming, broadcasting data of the intended service is received from the home service provider over the interactive network accessible to the terminal.

25. The terminal apparatus of claim 19, wherein if the roaming type is the service roaming, broadcasting data of the intended service is received from the home service provider over a broadcasting network belonging to the foreign service provider.

26. The terminal apparatus of claim 19, wherein if the roaming type is the service roaming, the mobility manager receives available service information for a roaming user from the home service provider through the foreign service provider, selects the intended service based on the available service information, and notifies the foreign service provider of the selected service.

27. The terminal apparatus of claim 19, wherein the mobility manager receives from the home service provider roaming information indicating if user authorization is required during roaming to the foreign network, and performs roaming to the foreign network without the user authorization for the terminal between the home service provider and the foreign service provider, if the roaming information indicates that the user authorization is not required.

28. A network apparatus for providing a roaming service to a terminal in a mobile broadcasting system, comprising:
a home service provider to which a terminal capable of receiving a broadcasting service has subscribed to; and
a foreign service provider for
receiving a roaming proposal message from the terminal when the terminal enters from a home network operated by the home service provider into a foreign network,
determining if a roaming type indicated by the roaming proposal message is user roaming or service roaming,
providing an intended service to the terminal from the foreign service provider, if the roaming type is the user roaming, and
receiving the intended service from the home service provider and providing the intended service to the terminal, if the roaming type is the service roaming.

29. The network apparatus of claim 28, wherein if the roaming type is the user roaming, the foreign service provider sends a response message allowing the user roaming for the roaming proposal message, and provides an access key for the intended service to the terminal, upon receipt of a confirm message from the terminal.

30. The network apparatus of claim 29, wherein at least one of the roaming proposal message, the response message, and the confirm message is delivered over an interactive network connected to the foreign service provider and accessible to the terminal.

31. The network apparatus of claim 28, wherein if the roaming type is the service roaming, the foreign service provider sends a response message allowing the service roaming for the roaming proposal message, and performs resource allocation negotiation for provisioning of the intended service between the home service provider and the foreign service provider, upon receipt of a confirm message from the terminal.

32. The network apparatus of claim 31, wherein at least one of the roaming proposal message, the response message, and the confirm message is delivered over an interactive network connected to the foreign service provider and accessible to the terminal.

33. The network apparatus of claim 28, wherein if the roaming type is the service roaming, broadcasting data of the intended service is sent from the home service provider to the terminal over an interactive network accessible to the terminal.

34. The network apparatus of claim 28, wherein if the roaming type is the service roaming, broadcasting data of the intended service is sent from the home service provider to the terminal over a broadcasting network belonging to the foreign service provider.

35. The network apparatus of claim 28, wherein if the roaming type is the service roaming, the foreign service provider sends available service information for a roaming user from the home service provider to the terminal, and is notified of the intended service selected based on the available service information from the terminal.

36. The network apparatus of claim 28, wherein the home service provider sends to the terminal roaming information indicating whether user authorization is required during roaming to the foreign network, and performs roaming to the foreign network without the user authorization for the terminal with the foreign service provider, if the roaming information indicates that the user authorization is not required.
